(19) United States
(12) Patent Application Publication
(10) Pub. No.: US 2004/0245993 A1
(43) Pub. Date: Dec. 9, 2004

(54) Gas ionization sensor

(76) Inventor: Ulrich Bonne, Hopkins, MN (US)

Correspondence Address: HONEYWELL INTERNATIONAL INC., 101 COLUMBIA ROAD, P O BOX 2245, MORRISTOWN, NJ, 07962-2245, US

(21) Appl. No.: 10/750,483

(22) Filed: Dec. 31, 2003

Related U.S. Application Data
(63) Continuation-in-part of application No. 10/672,483, filed on Sep. 26, 2003.
(63) Continuation-in-part of application No. 10/671,930, filed on Sep. 26, 2003.
(60) Provisional application No. 60/440,108, filed on Jan. 15, 2003.
(60) Provisional application No. 60/500,821, filed on Sep. 4, 2003.
(60) Provisional application No. 60/414,211, filed on Sep. 27, 2002.

(51) Int. Cl. G01N 27/62

(52) U.S. Cl. 324/464

(57) ABSTRACT

A sensor having electrodes connectable to an AC or DC voltage for powering an electrical discharge such as a corona, glow, arc, or the like. Additional electrodes connectable to analysis voltage may be proximate to the discharge providing electrodes. The discharge may ionize a sample fluid of varying chemical composition, flowing through a channel where the electrodes are situated. The discharge may be part of a group of sensors sensing the fluid flowing from a particle filter, gas chromatograph (GC) separator, thermal conductivity detector (TCD), optical sensors, photo ionization detector (PID), and to additional micro discharge devices (MDDs) and a mass spectrometer and/or a processor for analysis and processing to obtain results and information about the sample fluid composition.

The present application claims priority under 35 U.S.C. § 119(e) (1) to co-pending U.S. Provisional Patent Application No. 60/440,108, filed Jan. 15, 2003, and entitled “PHASED-III SENSOR”, wherein such document is incorporated herein by reference. The present application also claims priority under 35 U.S.C. § 119(e) (1) to co-pending U.S. Provisional Patent Application No. 60/500,821, filed Sep. 4, 2003, and entitled “PHASED V, VI SENSOR SYSTEM”, wherein such document is incorporated herein by reference. The present application claims priority as a continuation-in-part to co-pending U.S. Nonprovisional Application No. 10/672,483, filed Sep. 26, 2003, and entitled “PHASED MICRO ANALYZER V, VI”, which claims the benefit of U.S. Provisional Application No. 60/414,211, filed Sep. 27, 2002, wherein the co-pending U.S. Nonprovisional Application No. 10/672,483 is incorporated herein by reference. The present application claims priority as a continuation-in-part to co-pending U.S. Nonprovisional Application No. 10/671,930, filed Sep. 26, 2003, and entitled “PHASED MICRO ANALYZER III, IIIA”.

### BACKGROUND

The present invention pertains to detection of fluids. Particularly, the invention pertains to ionization structures, and more particularly to the application of the structures as sensors for the identification and quantification of fluid components. The term “fluid” may be used as a generic term that includes gases and liquids as species. For instance, air, gas, water and oil are fluids.

Aspects of structures and processes related to fluid analyzers may be disclosed in U.S. Pat. No. 6,393,894 B1, issued May 28, 2002, to Ulrich Bonne et al., and entitled “Gas Sensor with Phased Heaters for Increased Sensitivity,” which is incorporated herein by reference; U.S. Pat. No. 6,308,553 B1, issued Oct. 30, 2001, to Ulrich Bonne et al., and entitled “Self-Normalizing Flow Sensor and Method for the Same,” which is incorporated herein by reference.

Presently available gas composition analyzers may be selective and sensitive but lack the capability to identify the component(s) of a sample gas mixture with unknown components, besides being generally bulky and costly. The state-of-the-art combination analyzers GC-GC and GC-MS (gas chromatograph—mass spectrometer) approach the desirable combination of selectivity, sensitivity and smartness, yet are bulky, costly, slow and unsuitable for battery-powered applications. In GC-AED (gas chromatograph—atomic emission detector), the AED alone uses more than 100 watts, uses water to cool its microwave discharges and is costly.

Micro gas chromatography (μGC) detectors should be fast responding (<1 ms), sensitive but not selective to specific compounds, of simple construction and low-cost, compact, and low-power (˜ mW). Presently available or conceived μGC detectors are either not very sensitive, such as thermal conductivity sensors (≧10 to 100 ppm of analyte); too selective to specific compounds such as fluorescence and electron-capture detectors; not low-cost such as the typical price tags in year 2003 of about $600, $3000 and upwards for many GC detectors; prone to drift due to soiled optics as micro-discharge devices (MDDs) monitored via spectral analysis; or not low-power such as the AEDs, as mentioned above.

### SUMMARY

The present detector system combines the sensitivity of photo-ionization detectors (PIDs) (down to 10 ppb), the non-specificity of TCDs, PIDs and plasma micro discharge devices (MDDs), low-power consumption (mW), short response time (<1 ms), simple and low-cost design enabling MEMS co-planar fabrication and integration with μGC components without the need for complex design or micro-processing of photo-detectors, but offer ruggedness and reliability, thereby enabling operation at elevated temperatures and with relative immunity to soiling of optical elements.

### BRIEF DESCRIPTION OF THE DRAWING

FIGS. 1a and 1b illustrate a hollow-cathode discharge plasma and photo ionization detector in a rectangular flow channel;

FIG. 2 is an illustration of a hollow-cathode “electrodeless” AC discharge plasma and photo ionization detector;

FIG. 3 shows an electrode layout of an ionization detector having a co-planar design;

FIG. 4 shows an electrode layout of an ionization detector having a another co-planar design;

FIG. 5 shows an illustration of an ionization detector having prong- or interdigitated, finger-like co-planar electrodes;

FIGS. 6a, 6b, 6c and 6d illustrate a capacitive discharge or AC device; and

FIGS. 7, 8 and 9 show spectral emission intensity outputs of micro discharge versus wavelength for macro discharges of pure N₂ from a balloon, exhaled breath from a balloon, and automobile exhaust from a balloon, respectively; and

FIG. 10 reveals a micro gas analyzer system, which may be connected upstream of the gas ionization sensor.

### DESCRIPTION

The essence of the invention is to harness both the charge carriers generated in a glow-discharge plasma and those generated by additional photo-electric effects of the discharge's UV spectral emission, for the detection of changes in the gas composition of a sample gas stream as occurs, e.g., at the exit of a GC or μGC.

The present detector may have the following advantages over previously proposed or offered gas composition sensing devices. It may have a more advantageous combination of desired detector attributes (low-power, hi-speed, rugged and reliable, compactness, integratable with MEMS devices such as PHASED, simple and low-cost design, no need for drift-prone optical components), than other devices or approaches considered, previously. Further, it may be co-planar, simpler and lower-cost design than designs based on tubular discharge devices. It may consume less energy than conventional GC discharge detectors such as AEDs and be more temperature change tolerant than other devices involving photo-detectors, TCDs or flame ionization detectors (FIDs). No detector gas storage tank such as H₂ is needed for this detector as otherwise needed H₂ for FIDs. Also, no 10 to 12 eV UV window is needed, since the source and ionization test gas are either close together, or may be kept separate without a window by the assurance of laminar stratification, especially if a small flow of UV-transmissive discharge gas is provided.

The present MDD-ionization combination may enable high power density of the discharge (10⁵-10⁶ W/cm³ according to the University of Illinois), short purge time constant and thus also shorter response to new passing gas peaks and greater sensitivity to their composition (rather then re-discharge old plasma gas) than macro-discharge devices. The present device may be more manufacturable than tubular structure discharge devices (such as those for ozone generators). Also, there may be advantageous use of ionization electrode materials with a self-generated oxide coating.

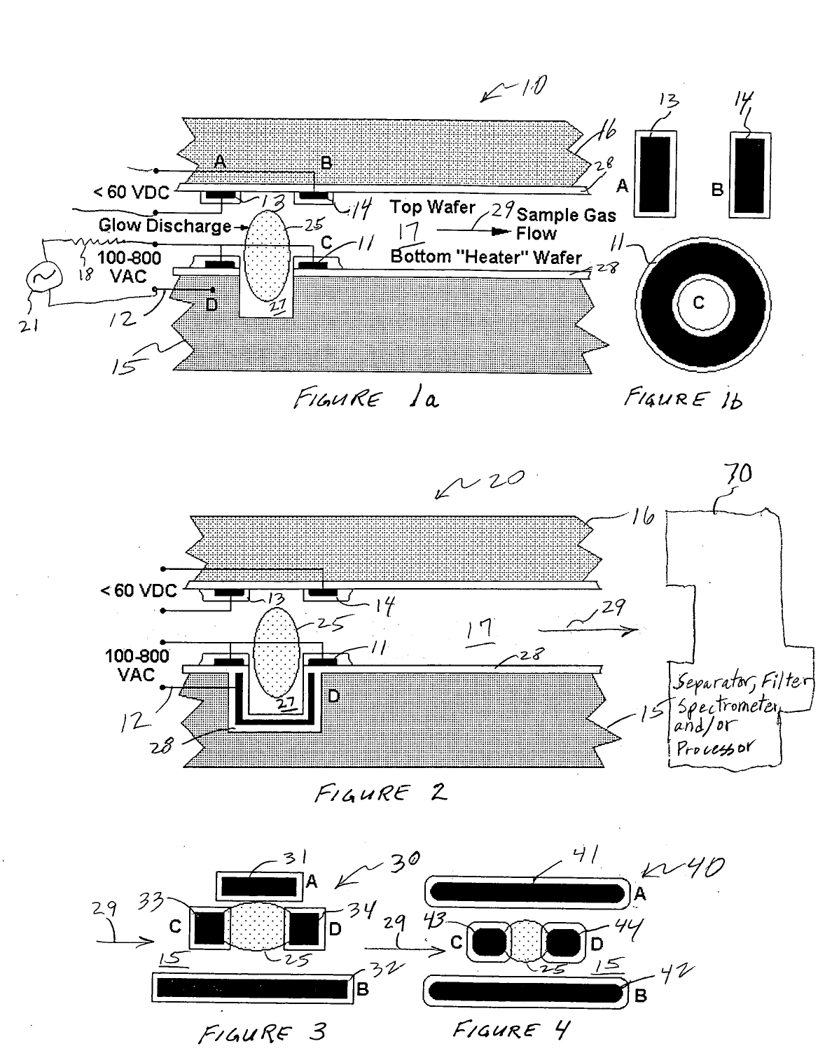

FIGS. 1a and 1b illustrate a hollow-cathode discharge plasma and photo ionization detector in a rectangular flow channel, e.g., for a gas chromatograph (GC). The Figures represent a plasma-photo ionization detector 10 for an analyzer system such as a GC. It is a micro discharge device (MDD) 10 that has discharge electrodes 11 and 12 for providing a plasma glow discharge 25. Source 21 may provide a higher voltage, e.g., 100 to 800 VAC, than the operating voltage, which may be needed for the ignition or start of the discharge 25, voltage to the electrodes 11 and 12 and the current of which, after the start of the discharge 25, the may be then lowered and limited, respectively, by a load resistor 18 to achieve an operation of the discharge device 10 in the low 0.01 to 1 mW range of dissipated power (with about 100 VAC). The operation may involve a capacitive discharge occurring at a frequency from about 20 kHz to 20 MHz between electrodes 11 and 12. Electrode 12 may consist of the low conductivity silicon chip substrate material 15. The ionization current may be measured via a relatively low-voltage DC circuit having a voltage source 22 of less than 60 VDC. Such DC circuit may minimize interference between the-two circuits of discharge and current measurement.

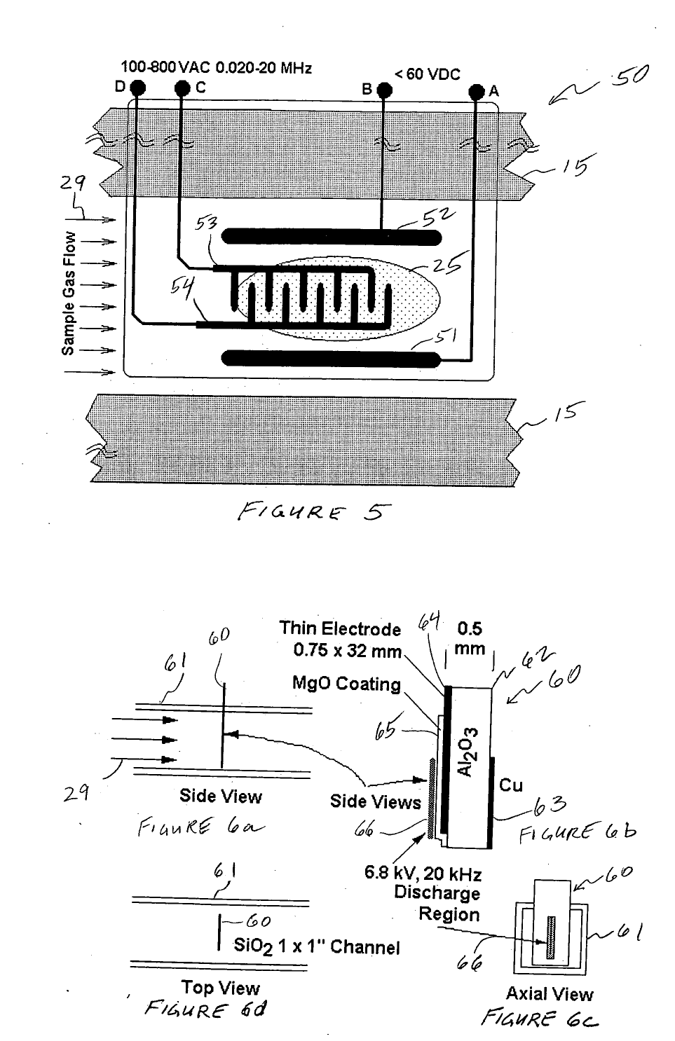

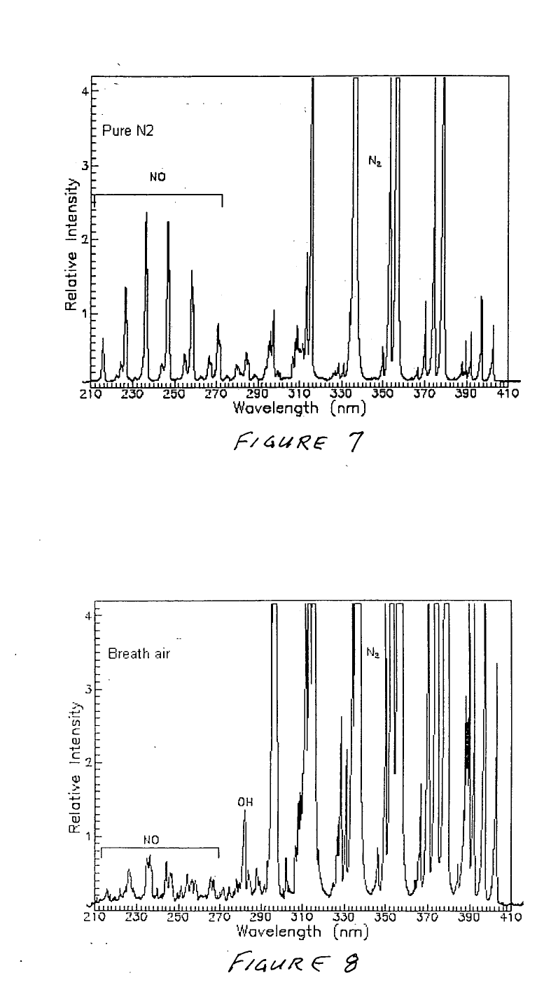

The device of FIG. 2 uses a design similar to that of FIGS. 1a and 1b, except for depositing the electrode 12 into the hollowed out area 27 on the insulating film 28 (e.g., SiO₂, Si₃N₄, MgO) and covering the electrode with such insulating dielectric as well. One may note that in both devices 10 and 20, electrodes 11, 12, 13, 14, and thus the leads to them, may be located on two wafers 15 and 16. Electrodes 11 and 12 may be on the bottom wafer 15. Electrodes 13 and 14 may be attached to the top wafer. In both devices 10 and 20, the top wafer 16 may form the gas flow channel 17, for the sample gas flow 29, of the separation column, and the bottom wafer 15, in the situation of PHASED sensors, may support the column heaters.

Devices 30 and 40 in FIGS. 3 and 4 may use a co-planar electrode structure, where the collection electrodes 31, 32, and discharge electrodes 33, 34 of detector 30 may be deposited on the same wafer or substrate, e.g., wafer or substrate 15. Likewise, collection electrodes 41, 42 and discharge electrodes 43, 44 may be deposited on the same wafer or substrate 15 of detector 40. The dimension and location differences between detectors 30 and 40 involve minimizing high e-field regions between the two circuits (discharge and ionization), and insuring that the ion+electron collection electrodes 31, 32 field is lower than the field between the discharge electrodes 33, 34. One of the collection electrodes 31, 32 of device 30 may be smaller than the other. Collection electrodes 41 and 42 of device 40 may be about the same size. The device 30 discharge electrodes 33 and 34 may have a greater distance between them for larger discharges than the electrodes 43 and 44 of device 40.

The photo and plasma ionization device 50 may maintain a high-power density (W/cm³) and brightness of micro-discharges, i.e., higher than that of macro-discharge devices, while increasing the total ion+electron+photon output relative to the outputs of the above noted devices 10, 20, 30 and 40. Discharge electrodes 53 and 54 may have an inter-meshed prong- or finger-like (i.e., interdigitated) design for greater electrode-to-electrode area for potentially providing a larger and more intense discharge 25. One may place the collection electrodes 51 and 52 and discharge electrodes 53 and 54 at a position further downstream of the channel or column to optimize collection in a high sample gas flow 29 (about 100 to 200 cm/s). Co-planar electrodes 51, 52, 53 and 54 may be situated on the heater wafer 15.

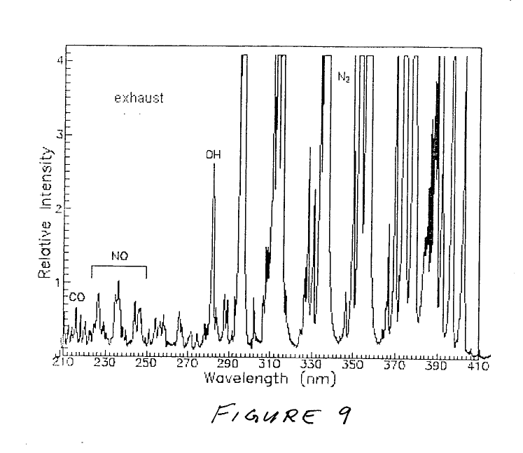

FIGS. 6a, 6b, 6c and 6d describe a capacitive glow discharge device 60 which is a macro-discharge assembly. It may be a set-up that is based on an ozone generator. FIG. 6a shows a side view of a channel 61 with a gas flow 29 going through it. Channel 61 may be a 1 inch by 1 inch channel composed of SiO₂. Situated in channel 61 is a side view of discharge device 60 which is shown in more detail in a FIG. 6b side view. Device 60 may have a substrate layer 62 composed of Al₂O₃ with a thickness of about 0.5 mm (19.7 mils). On a portion of the back side of substrate 62 may be a layer of Cu. On the front side of layer 62 may be a layer 64 which is a thin electrode having dimensions of 0.75 mm by 32 mm. On a significant portion of electrode 64 may be an electrode cover film 65. Electrode cover film 65 may be composed of, for example, MgO, SiO₂ or Si₃N₄. On film 65 may be a discharge region 66. Region 66 may sustain about a 20 kHz 6.8 kV discharge. FIG. 6c is an axial view of device 60 with discharge region 66 at its front and situated in channel 61. FIG. 6d is a top view of device 60 situated in channel 61.

The expected spectral output of an MDD 10, 20, 30, 40 or 50 may cover N₂, O₂ and OH and other analyte plasma reaction products in normal air as a carrier gas. One may note the spectra of these fluids in FIGS. 7, 8 and 9, respectively, with relative intensity versus wavelength, obtained with the macro-discharge assembly 60 shown in FIGS. 6a, 6b, 6c and 6d. The ionization sensor of the sample fluid 29 may be part of a set of spectral and other sensors, all geared to maximize reliability of detection and quantification of the analytes of interest in the fluid, especially when discharge current, discharge-induced photo-ionization and spectral emission outputs of MDDs can be detected simultaneously and/or in relation to each other as sample gas composition changes.

FIG. 7 involves a macro discharge in pure N₂ from a balloon. FIG. 8 involves a macro discharge in exhaled breath from a balloon. FIG. 9 involves a macro discharge in automobile exhaust from a balloon. Data for FIGS. 7-9 were recorded by Caviton, Inc. One may note the various wavelengths of NO emission at 247.2 or 258.8±1.4 nm, and reference N₂ at 336.9 or 357.5±2 nm. Other bands of OH, C₂ and CH may be known from flame spectras. Still others may be known from absorption measurements of NH₃, CO, SO₂, and the like. When GC peaks of CO, CO₂, CH₄, CnHm, etc., elute, more ions+electrons and different spectral emission bands are likely to be generated, all contributing to a simultaneous change (generally an increase) in the measurable ionization current. There may be measurable changes in discharge current as a composition of the gas in the discharge changes with time, in accordance with concentration peaks eluting from a gas chromatography analyzer.

Some features of the invention include coplanar MEMS MDDs and ionization sensing electrodes, interdigitated MDDs to achieve both high power density (i.e., brightness and high UV and ion+electron output), short residence time of discharge gas due to short diffusion distances across the microdischarge (10 to 100 microns), which favors sensitivity to sample gas, and high total power and ionization signal and fast response. These may be all with co-planar ionization collection electrodes. There may be a positioning of the ionization collection electrodes shifted downstream, for optimal collection of ions in a fast gas flow (100 to 200 cm/s). An application of DC ionization collection voltage may be had for least interference between charge carrier generation and measurement circuits.

To minimize the probability, P, of mis-identifying a gas mixture component, it is desirable to obtain as many independent measurements of an analyte as possible. Measurements with GC-MS (MS=mass spectrometer), GC-GC and GC-GC-MDD may be noted. The point is that sensing MDDs spectral emission together with ionization current features can help to reduce P. Such features could be AC and DC measurements, ion-drift (i.e., ionization current) phase-lag relative to the known generation of the charge carriers, and rectification effects enabled by the use of dissimilar electrodes, as practiced in flame rectification circuits.

There may be an application of AC ionization collection voltage with a pair of equal electrodes and a phase-locked amplifier tied to ion generation frequency, to enable measurement of ionization amplitude and phase shift, which may relate to the size and polarity of the ion, as in ion drift spectrometry. On the other hand, there may be an application of AC ionization collection voltage with a pair of un-equal electrodes and a phase-locked amplifier tied to an ion generation frequency, to enable measurement of ionization amplitude, phase shift and rectification, which may be had to better quantify the size and polarity of the ion, and to further reduce P.

There may be the use of a differential ionization (really a charge-carrier) collection circuit, where the steady-state input sample gas ionization may be compared with that of gas exiting from the GC, which features the separated gas constituent peaks. Also, one may sense MDD power and/or current and/or ionization, all vs. applied voltage and frequency, in addition to MDD spectral output and ionization current to reduce P.

The present ionization gas detectors may include the following items. There may be the use of plasma hollow-cathode micro glow discharge device (MDD) for gas sensing via spectral emission of unknown gas mixture samples, to generate pairs of ions and electrons and additional pairs via photo-ionization, especially of gas mixture components (i.e., analytes) of low ionization potential. Also, there may be the use of co-planar electrodes (e.g., thick film-Pt on alumina) for MEMS MDDs but with added co-planar ionization sensing electrodes.

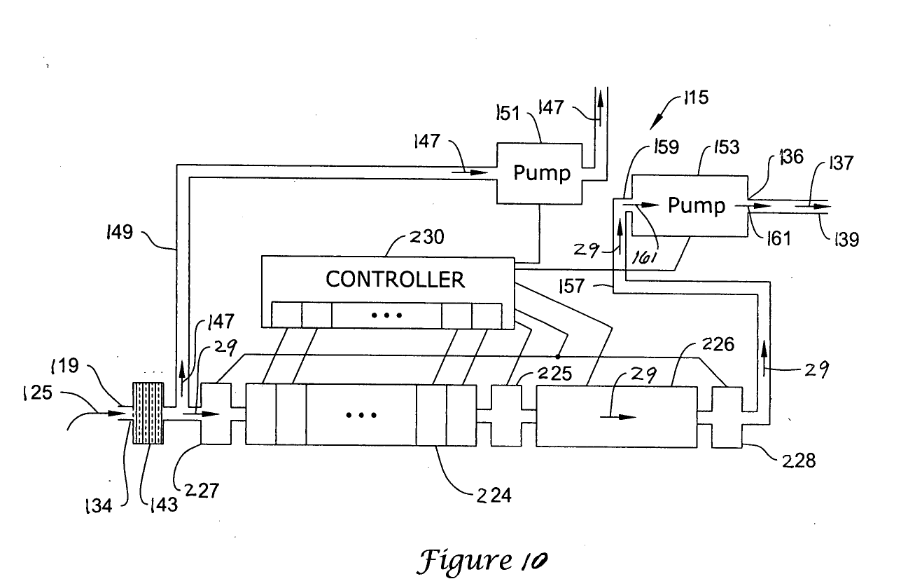

FIG. 10 reveals certain details of micro gas apparatus 115. Sample stream 125 may enter input port 134 from pipe or tube 119. There may be a particle filter 143 for removing dirt such as soot from exhaust and other particles from the stream of fluid 125 that is to enter apparatus 115. This removal is for the protection of the apparatus and the filtering should not reduce the apparatus' ability to accurately analyze the composition of fluid 125. Dirty fluid (with suspended solid or liquid non-volatile particles) might impair proper sensor function. A portion 29 of fluid 125 may flow through the first leg of a differential thermal-conductivity detector (TCD, or chemi-sensor (CRD), or photo-ionization sensor/detector (PID), or other device) 227 and a portion 147 of fluid 125 may flow through tube 149 to a pump 151. By placing a “T” tube immediately adjacent to the inlet 29, sampling with minimal time delay may be achieved because of the relatively higher flow 147 to help shorten the filter purge time. Pump 151 may cause fluid 147 to flow from the output of particle filter 143 through tube 149 and exit from pump 151. Pump 153 may effect a flow of fluid 29 through the sensor via tube 157. From detector 227, fluid 29 may flow through ionizer 224, flow sensor 225, separator 226 and through detector 228 (which may be like detector 227) on to pump 153. Separator 226 may be for separating individual gas constituents of sample fluid 29, particularly if the fluid is a gas mixture. There may be additional or fewer pumps, and various tube or plumbing arrangements or configurations for system 115 in FIG. 10. Data from detectors 227 and 228, flow sensor 225, ionizer 224, and separator 226 may be sent to controller 230 for processing, analysis and results about fluid 29.

Although the invention has been described with respect to at least one illustrative embodiment, many variations and modifications will become apparent to those skilled in the art upon reading the present specification. It is therefore the intention that the appended claims be interpreted as broadly as possible in view of the prior art to include all such variations and modifications.

What is claimed is:

1. An ionization sensor comprising:
a first electrode situated in a first plane;
a second electrode situated in the first plane;
a third electrode situated in a second plane; and
a fourth electrode situated in a third plane; and wherein:
the second plane is approximately parallel to the first plane; and
the first and second electrodes are proximate to the third and fourth electrodes.

2. The sensor of claim 1, wherein:
the first and second electrodes have first and second terminals for connection to a first power supply; and
the third and fourth electrodes have first and second terminals for connection to a second power supply.

3. The sensor of claim 2, wherein the third and fourth electrodes form an electrical discharge gap.

4. The sensor of claim 3, wherein the first, second and third planes are approximately in the same plane.

5. The sensor of claim 3, wherein:
the first plane is situated on a first surface of a first wafer;
the second plane is situated on a second surface of a second wafer; and
the first and second wafers form a fluid flow channel.

6. An ionization sensor comprising:
a first electrode having a first plurality of prongs situated approximately in a plane; and
a second electrode having a second plurality of prongs situated approximately in the plane and proximate to the first plurality of prongs to form a plurality of electrical discharge gaps between the first and second electrodes.

7. The sensor of claim 6, further comprising a channel, wherein the channel comprises the first and second electrodes.

8. The sensor of claim 7, wherein the channel is a fluid flow channel.

9. The sensor of claim 8, further comprising a spectrometer optically coupled to the plurality of electrical discharge gaps.

10. The sensor of claim 9, wherein the plane is approximately parallel to a fluid flow direction of the channel.

11. The sensor of claim 9, further comprising:
a third electrode situated approximately in the plane and proximate to the first and second electrodes; and
a fourth electrode situated approximately in the plane and proximate to the first and second electrodes.

12. The sensor of claim 11, wherein:
an A.C. voltage supply is connected to the first and second electrodes; and
a D.C. voltage supply is connected to the third and fourth electrodes.

13. The sensor of claim 12, wherein first and second electrodes have a dielectric coating.

14. The sensor of claim 13, wherein the third and fourth electrodes have no dielectric coating.

15. The sensor of claim 9, further comprising a processor connected to the spectrometer.

16. An ionization sensing means comprising:
means for conveying a flow of a fluid; and
means for providing an ionizing electrical discharge situated in the means for conveying a flow of a fluid.

17. The means of claim 16, wherein the fluid is a gas.

18. The means of claim 17, further comprising a means for enabling measurement of a variable discharge current as a composition of the gas in the discharge changes with time.

19. The means of claim 18, wherein the composition of the gas in the discharge changes with time in accordance with concentration peaks eluting from a gas chromatography analyzer.

20. The means of claim 16, further comprising a spectrometer optically coupled to the channel.

21. The means of claim 16, further comprising means for separating individual gas constituents of a sample fluid, if the fluid is a gas mixture.

22. The means of claim 21, further comprising means for determining thermal conductivity connected to the means for separating.

23. The means of claim 22, further comprising means for determining flow of a fluid situated proximate to the means for separating.

24. A method for ionization sensing, comprising:
providing a channel for a flow of a fluid; and
providing an ionization electrical discharge in the channel.

25. The method of claim 24, further comprising providing spectral analysis of light in the channel.

26. The method of claim 25, further comprising making a plurality of measurements with the spectral analysis of light in the channel to minimize false positives.

27. The method of claim 25, further comprising:
providing flow sensing in the channel; and
providing thermal conductivity detection proximate to the channel.

28. The method of claim 27, further comprising providing separating in the channel.

29. A gas ionization sensor comprising:
a first electrode situated in a plane; and
a second electrode situated in the plane; and wherein:
the first and second electrodes are discharge power electrodes; and
the first and second electrodes are discharge current sense electrodes.

30. The sensor of claim 29, wherein the first and second electrodes sense presence and changes of analytes in a gas proximate to the electrodes.
